(19) United States
(12) Patent Application Publication
(10) Pub. No.: US 2023/0331516 A1
(43) Pub. Date: Oct. 19, 2023

(54) ELEVATING MACHINE OPERATION INFORMATION DISPLAY SYSTEM

(71) Applicant: Hitachi, Ltd., Tokyo (JP)

(72) Inventors: Wataru ONO, Tokyo (JP); Kenji OTSUKA, Tokyo (JP); Masayuki OKAMOTO, Tokyo (JP)

(21) Appl. No.: 18/025,918

(22) PCT Filed: Feb. 16, 2021
(86) PCT No.: PCT/JP2021/005634

§ 371 Date: Mar. 13, 2023

(51) Int. Cl. B66B 3/00; B66B 5/00

(52) U.S. Cl. CPC B66B 3/002; B66B 5/0018; B66B 5/0037; B66B 5/0012

(57) ABSTRACT

This elevating machine operation information display system comprises: a collection unit that collects, from one or more control boards that control a plurality of elevating machines installed in the same site, elevating machine operation information for each period set for the elevating machine; and a data conversion unit that converts the collected operation information to operation information at preset intervals. In addition, elevating machine usage information that includes at least one of the average call duration and the number of people landing and exiting at halls in the site are caused to be output and displayed on the basis of the operation information converted by the data conversion unit.

### TECHNICAL FIELD

The present invention relates to an elevating machine operation information display system.

### BACKGROUND ART

A large number of elevators are installed in large buildings and commercial facilities. Usually, a plurality of elevators installed in a building is collectively managed by a group management control board. In addition, the service state under the control of the group management control board of each elevator is monitored at a disaster prevention center in the building. Further, the service state of each elevator by the group management control board is also remotely monitored at a monitoring center installed by the vendor of the elevators.

A plurality of group management control boards may be disposed in one building depending on the number of elevators installed and installation conditions. For example, in the case of a high-rise building, control may be performed by different group management control boards for a high-rise floor elevator that ascends and descends from the first floor to a high-rise floor and a low-rise floor elevator that ascends and descends only between low-rise floors. There is a case where a plurality of elevators in one building is all manufactured by the same vendor, but there are many cases where elevators of different vendors are installed for each elevator controlled by the group management control board.

The group management control board has different specifications for each vendor, and has different specifications depending on the model even for the same vendor. When a plurality of group management control boards having different specifications is installed in one building, elevator monitoring devices installed in the disaster prevention center corresponding to the respective specifications are individually prepared. Therefore, a person performing the monitoring operation needs to perform monitoring using a plurality of monitoring devices.

Patent Literature 1 describes a technique of performing diagnosis for maintenance of elevators of a plurality of models by converting operation/diagnosis data of the elevators of different models using a conversion program and then storing the data in a database.

### CITATION LIST

### Patent Literature

Patent Literature 1: JP 2005-231850 A

### SUMMARY OF INVENTION

### Technical Problem

Incidentally, it is known that the data of the operation status of the elevator obtained by the group management control board is useful for various control and analysis. For example, from the data of the operation status of the elevator in the building, the flow of people on each floor in the building can be grasped, and facilities such as air conditioners in the building can be appropriately controlled. In addition, by analyzing the operation status of the elevator in the building, it is possible to determine the busy status of tenants such as stores occupying each floor such as whether the number of users is larger or smaller than in other stores of the same industry type.

As described above, the data of the operation status of the elevator is data having high utility value, but it cannot be said that advanced use is conventionally performed. That is, as described in Background Art, the group management control board has different specifications depending on the vendor and the model, and does not collect data from elevators of different vendors.

Here, for example, Patent Literature 1 proposes collectively performing diagnosis for maintenance of a plurality of elevators by converting operation/diagnosis data of the elevators of different models using a conversion program. The operation data necessary for the diagnosis for maintenance is, for example, operation data directly related to the service of the elevator, such as the operation time of the hoist, the number of times of opening and closing the door, and the actuation status of the brake.

On the other hand, in order to determine the flow of people in the building, the busy status of tenants, and the like from the operation status of the elevator, it is necessary to collect data of a more advanced operation status different from the operation status necessary for maintenance.

However, conventionally, in the group management control boards of different models and vendors, the data formats to be collected are completely different from each other, and it has not been performed to collect data from various types of group management control boards and analyze details of the status in the building such as the flow of people, and it has been desired to be achieved.

### Solution to Problem

In order to solve the above problem, for example, the configuration described in the claims is adopted.

The present application includes a plurality of means for solving the above problem, and as an example thereof, an elevating machine operation information display system includes: a collection unit that collects, from one or more control boards that control a plurality of elevating machines installed in the same site, operation information of the elevating machines for each period set for the elevating machines; a data conversion unit that converts the collected operation information to operation information at preset intervals; and an output unit that outputs, for display, elevating machine usage information that includes at least one of an average call duration and the number of people landing and exiting at halls in the site on the basis of the operation information converted by the data conversion unit.

### Advantageous Effects of Invention

According to the present invention, by displaying at least one of an average call duration and the number of people landing and exiting at halls in a site on the basis of operation information of a plurality of elevating machines installed in the site such as a building, it is possible to know whether or not the site is effectively utilized.

Problems, configurations, and effects other than those described above will be clarified by the description of an embodiment described below.

### BRIEF DESCRIPTION OF DRAWINGS

FIG. 1 is a configuration diagram illustrating an outline of an entire system according to an example embodiment of the present invention.

FIG. 2 is a diagram illustrating a concept of a flow of data according to an example embodiment of the present invention.

FIG. 3 is a block diagram illustrating an overall configuration of a system according to an example embodiment of the present invention.

FIG. 4 is a block diagram illustrating a configuration of a relay server according to an example embodiment of the present invention.

FIG. 5 is a flowchart illustrating a flow of processing of a group management control board and the relay server according to an example embodiment of the present invention.

FIG. 6 is a flowchart illustrating a flow of processing in a platform server and a user terminal according to an example embodiment of the present invention.

FIG. 7 is a diagram illustrating an example of a site information table according to an example embodiment of the present invention.

FIG. 8 is a diagram illustrating an example of a conversion rule table according to an example embodiment of the present invention.

FIG. 9 is a diagram illustrating an example of a database of service data according to an example embodiment of the present invention.

FIG. 10 is a diagram illustrating an example of a floor comparison screen according to an example embodiment of the present invention.

FIG. 11 is a diagram illustrating an example of a site comparison screen according to an example embodiment of the present invention.

FIG. 12 is a diagram illustrating an example of a display screen of an analysis result according to an example embodiment of the present invention.

### DESCRIPTION OF EMBODIMENTS

Hereinafter, an elevating machine operation information display system of an example embodiment of the present invention will be described with reference to the accompanying drawings.

### [Overall Configuration]

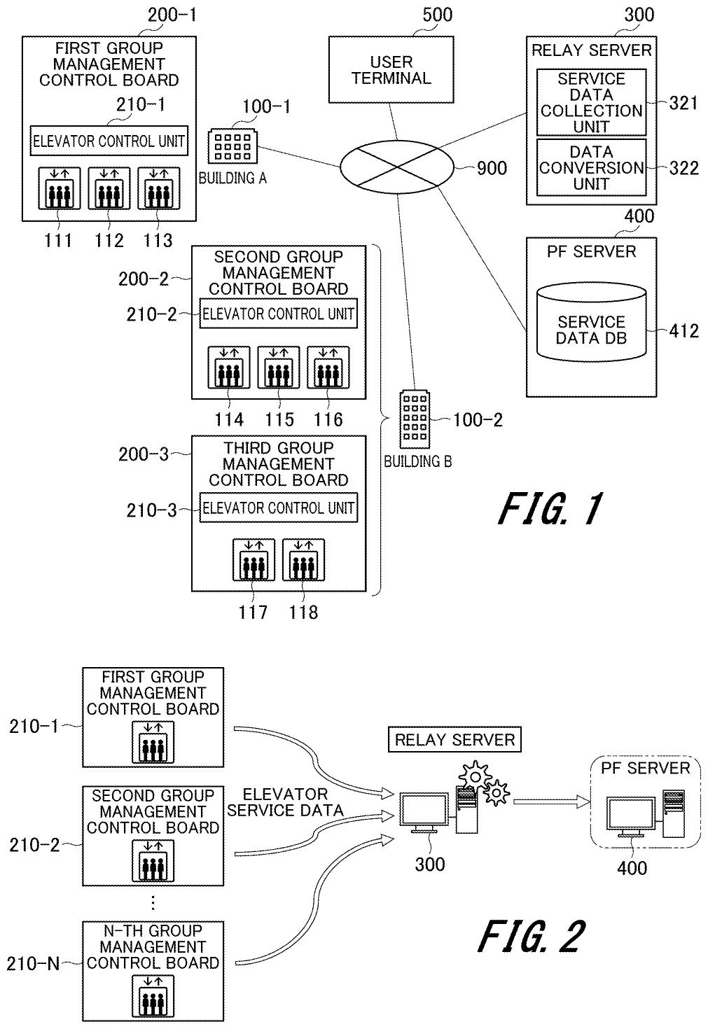

FIG. 1 illustrates a schematic configuration of an elevating machine operation information display system of an example embodiment of the present invention.

The system illustrated in FIG. 1 is a system that displays operation information of elevators 111, 112, 113, . . . which are elevating machines installed in a plurality of buildings 100-1, 100-2, . . . . A plurality of elevators is installed in each of the buildings 100-1, 100-2, . . . , and is group-managed by group management control boards 200-1, 200-2, 200-3, . . . installed in the buildings.

In FIG. 1, a configuration including the building A 100-1 and the building B 100-2 is described, but in practice, the configuration includes a larger number of buildings and group management control boards. In addition, in the following description, a place where an elevator such as a building is installed may be referred to as a site.

A first group management control board 200-1 is installed in the building A 100-1, and an elevator control unit 210-1 built in the first group management control board 200-1 group-manages three elevators 111, 112, and 113 in the building A 100-1.

In addition, a second group management control board 200-2 and a third group management control board 200-3 are installed in the building B 100-2, and five elevators 114 to 118 in the building B 100-2 are group-managed by the two group management control boards 200-2 and 200-3. In the second group management control board 200-2, an elevator control unit 210-2 performs group-management of the three elevators 114, 115, and 116. In the third group management control board 200-3, an elevator control unit 210-3 performs group management of the two elevators 117 and 118.

Note that, in the group management of the elevators, normally, processing of concentrically and appropriately managing the service of the plurality of elevators and equalizing the call duration, which is the time from when the call button of the landing of each floor is pressed, is performed, but the group management in the present example embodiment is not limited to performing such advanced group management. That is, the group management in the present example embodiment may have any management form as long as the service of the plurality of elevators is controlled by one control board. However, each of the group management control boards 200-1 to 200-3 has a function of collecting service data, which is operation information of at least the group-managed elevators. Note that details of the operation information (service data) of the elevators will be described below.

In addition, the elevators 111 to 118 and the group management control boards 200-1 to 200-3 may be of different models and vendors (manufacturers).

When the models and vendors of the elevators 111 to 118 and the group management control boards 200-1 to 200-3 are different, the data type, the data format, and the data collection interval when the group management control boards 200-1 to 200-3 collect the service data of the elevators 111 to 118 are not the same. In addition, the cycle of transmitting the data collected by the group management control boards 200-1 to 200-3 to the outside is not the same when the models and vendors are different.

The group management control boards 200-1 to 200-3 of each building 100-1 and 100-2 communicate with a monitoring center, which is not illustrated, installed for each vendor, and the monitoring center monitors occurrence of a failure, occurrence of confinement in a car, and the like. In addition, the control states of the group management control boards 200-1 to 200-3 can also be monitored by a disaster prevention center installed in each building 100-1 and 100-2.

Then, the group management control boards 200-1 to 200-3 of the system of the present example embodiment communicate with a relay server 300 installed separately from the monitoring center for each vendor or the disaster prevention center for each building via a network 900.

The relay server 300 includes a service data collection unit 321 and a data conversion unit 322. The service data collection unit 321 collects elevator service data from the group management control boards 200-1 to 200-3. The data conversion unit 322 converts the service data collected by the service data collection unit 321 into data in a unified format.

The service data converted into the unified format by the relay server 300 is sent to a platform server 400 via the network 900 and accumulated in a service data database 412 of the platform server 400. The platform server 400 analyzes the accumulated service data. Note that, in the drawings, the platform is described as PF, and the database is described as DB.

The service data and the analysis result accumulated in the service data database 412 of the platform server 400 are sent to a user terminal 500 via the network 900 and displayed by the user terminal 500. The user terminal 500 is a terminal of a business operator using the system of the present example embodiment. As a business operator that uses the system of the present example embodiment, for example, a developer or a realtor that manages the building A 100-1 and the building B 100-2 is assumed.

Note that, in FIG. 1, the network 900 that transmits data is described as one network, but another network may be used for each data transmission processing.

FIG. 2 illustrates a concept of a flow in which service data is collected from a plurality of group management control boards 200-1 to 200-N to the platform server 400 via the relay server 300. Here, it is an example in which N (N is any integer of 2 or more; hereinafter, the meaning of “N” is the same) group management control boards 200-1 to 200-N are prepared.

As illustrated in FIG. 2, each of the group management control boards 200-1 to 200-N transmits the service data to the relay server 300 as needed under conditions or in cycles set for each model.

The relay server 300 converts the received service data into service data in a unified format, and transmits the converted service data to the platform server 400.

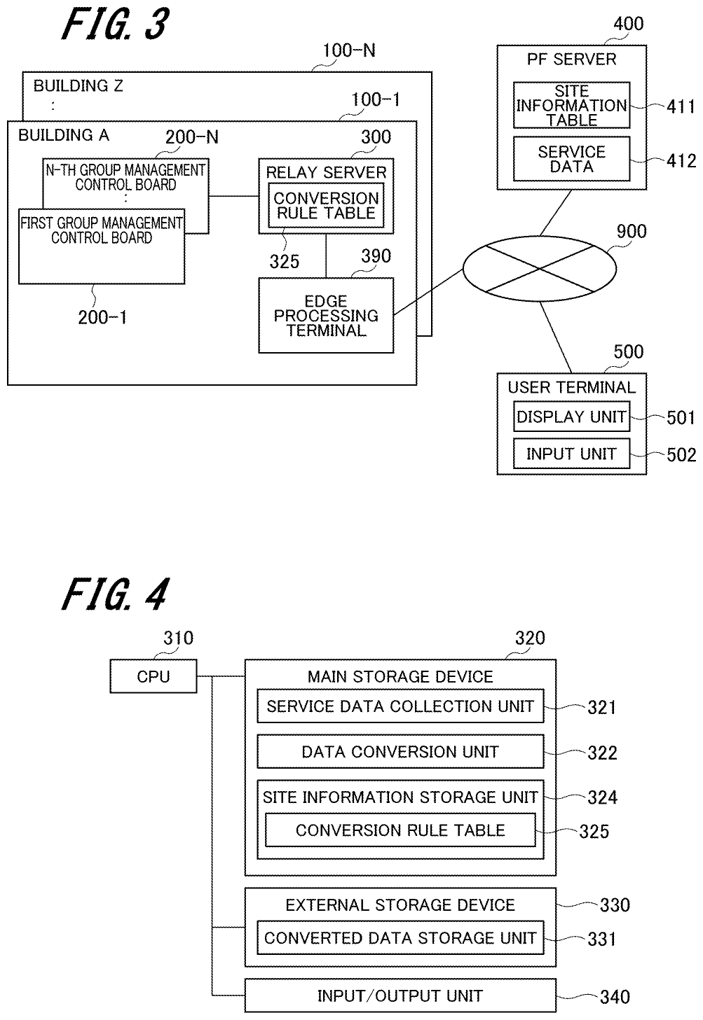

FIG. 3 illustrates a more detailed system configuration of the elevating machine operation information display system of the present example embodiment. FIG. 3 collectively illustrates configurations in the plurality of buildings 100-1 to 100-N.

In FIG. 3, the relay server 300 collects elevator operation information from the plurality of group management control boards 200-1 to 200-N installed in any of the N buildings 100-1 to 100-N. Here, the relay server 300 includes a conversion rule table 325, and converts the operation information collected from each of the group management control boards 200-1 to 200-N into operation information in a unified format.

The operation information converted into the information in the unified format by the relay server 300 is sent to the network 900 via an edge processing terminal 390 connected to the relay server 300, and is sent to the platform server 400 connected to the network 900.

The platform server 400 includes a site information table 411 and the service data database 412.

The site information table 411 stores information regarding the group management control boards 200-1 to 200-N installed in each building, which is a site. The service data database 412 stores the service data acquired from the relay server 300 and the analysis result of the service data.

The platform server 400 generates data for displaying the status of the site such as a building on the basis of the service data and the analysis result thereof stored in the service data database 412, and the generated display data is transmitted to the user terminal 500 via the network 900.

The user terminal 500 includes a display unit 501 and an input unit 502. The input unit 502 performs input processing of the display data received via the network 900. The display unit 501 performs display processing using the display data subjected to the input processing by the input unit 502.

### [Configuration of Relay Server]

FIG. 4 is a diagram illustrating a configuration of the relay server 300.

As illustrated in FIG. 4, the relay server 300 is configured as an information processing device, and includes a central processing unit (CPU) 310, a main storage device 320, an external storage device 330, and an input/output unit 340, which are each connected to a bus.

The CPU 310 forms a processing unit in the main storage device 320 by executing a program stored in the main storage device 320.

The processing unit formed in the main storage device 320 include the service data collection unit 321, the data conversion unit 322, and a site information storage unit 324. The site information storage unit 324 stores the conversion rule table 325.

In addition, a converted data storage unit 331 is formed in the external storage device 330.

The input/output unit 340 executes processing of inputting the service data or the like from the group management control boards 200-1 to 200-N and processing of outputting the converted data stored in the converted data storage unit 331 to the platform server 400.

### [Flow of Processing Between Group Management Control Board and Relay Server]

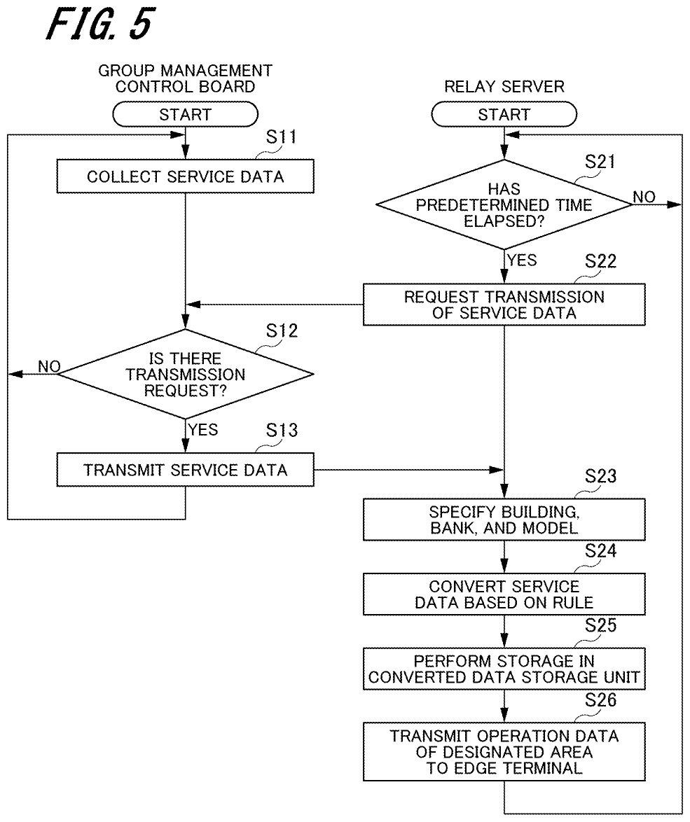

FIG. 5 is a flowchart illustrating a flow of collection of elevator service data by each of the group management control boards 200-1 to 200-N and processing of the service data by the relay server 300.

First, each of the group management control boards 200-1 to 200-N collects service data, which is operation information of the elevators group-managed by each of the group management control boards 200-1 to 200-N (step S11). Specific examples of the service data collected by the group management control boards 200-1 to 200-N will be described below, but each of the group management control boards 200-1 to 200-N collects various data regarding the service of the elevators.

The service data collected by each of the group management control boards 200-1 to 200-N is accumulated in a storage unit of each of the group management control boards 200-1 to 200-N. Note that when the formats and vendors of the group management control boards 200-1 to 200-N are different, the data collection conditions such as the cycle of collecting data by the group management control boards 200-1 to 200-N are not the same.

Then, each of the group management control boards 200-1 to 200-N determines whether there is a transmission request of the accumulated service data from the relay server 300 (step S12). When the transmission request is received in step S12 (YES in step S12), the group management control boards 200-1 to 200-N transmit the accumulated service data to the relay server 300 (step S13). At this time, the group management control boards 200-1 to 200-N may transmit all the accumulated service data, but may transmit only service data of a type required by the system of the present example embodiment.

In addition, when the transmission request is not received in step S12 (No in step S12), and after the service data is transmitted in step S13, each of the group management control boards 200-1 to 200-N returns to the service data collection processing in step S11.

Next, processing in the relay server 300 will be described.

First, the relay server 300 determines whether a predetermined time has elapsed since the previous service data was received (step S21). When it is determined in step S21 that the predetermined time has not elapsed since the previous service data was received (NO in step S21), the relay server 300 waits.

In addition, when it is determined in step S21 that the predetermined time has elapsed since the previous service data was received (YES in step S21), the relay server 300 makes a transmission request of the service data to each of the group management control boards 200-1 to 200-N (step S22).

Then, for the service data received after the transmission request, the relay server 300 specifies the building in which the elevator indicated by the data is installed, the bank indicating the elevator installation position, and the model of the elevator (step S23). The information of the specified building, bank, and model is added to the service data and stored in the service data collection unit 321.

Then, the data conversion unit 322 of the relay server 300 converts the service data stored in the service data collection unit 321 into service data in a unified format on the basis of the conversion rule for each model (step S24). At the time of this conversion, the data conversion unit 322 uses the conversion rule stored in the conversion rule table 325. The converted service data is stored in the converted data storage unit 331 of the external storage device 330 (step S25).

Thereafter, the relay server 300 transmits the operation data of the elevator in a designated area (specific building or floor) of the service data stored in the converted data storage unit 331 to the edge processing terminal 390 (step S26). The elevator operation data transmitted to the edge processing terminal 390 is transmitted to the platform server 400. Thereafter, when the processing of step S26 ends, the relay server 300 returns to the determination processing of step S21.

### [Flow of Processing in Platform Server]

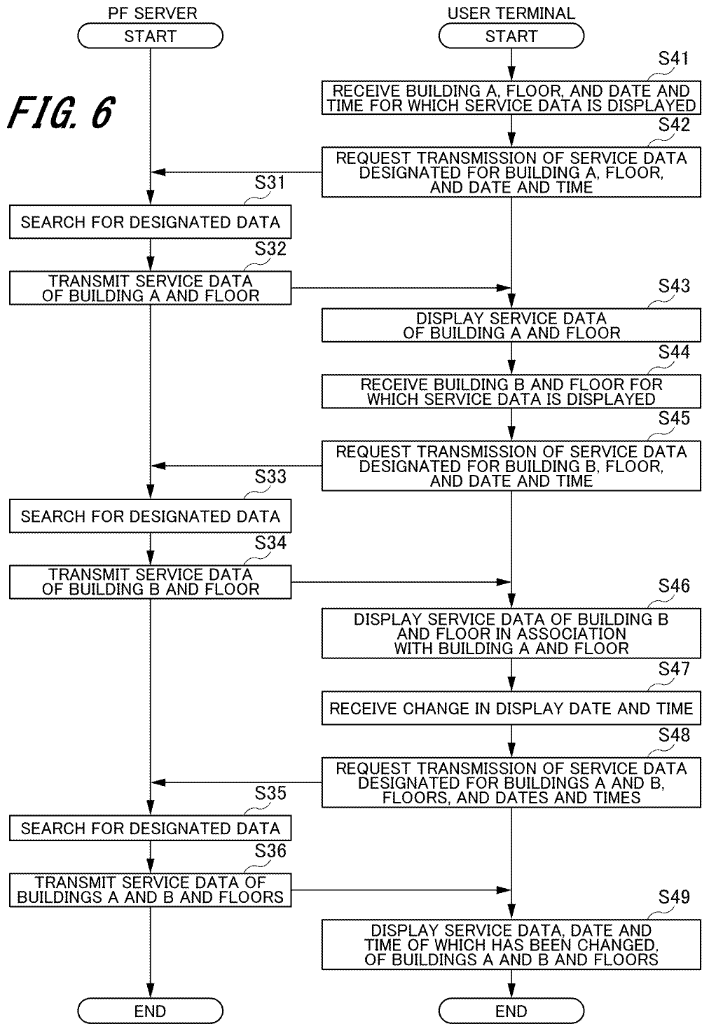

FIG. 6 is a flowchart illustrating a flow of processing in the platform server 400.

The processing for the service data accumulated by the platform server 400 is performed according to an instruction from the user terminal 500. That is, the user terminal 500 receives the building, the floor, and the date and time for which the service data is displayed, by the operation of the user using the user terminal 500 (step S41). Here, it is assumed that a specific period of each floor of the building A 100-1 illustrated in FIG. 1 is designated.

The user terminal 500 that has received the operation of the user makes a transmission request of the service data of the specific period of each floor of the corresponding building A 100-1 to the platform server 400 (step S42).

The platform server 400 that has received the transmission request searches for the designated service data from the accumulated data (step S31). Then, the platform server 400 transmits the searched service data of the building B 100-2 to the user terminal 500 (step S32). The service data may include an analysis result of the service data performed by the platform server 400.

Upon receiving the transmitted service data, the user terminal 500 displays the received service data of each floor of the building A 100-1 (step S43).

Thereafter, the user terminal 500 receives designation of another building, for example, the building B 100-2 and a floor by the operation of the user using the user terminal 500 (step S44).

The user terminal 500 that has received the operation of the user makes a transmission request of the service data of a specific period of each floor of the corresponding building B 100-2 to the platform server 400 (step S45). This period is, for example, the same as the period designated in step S42.

The platform server 400 that has received the transmission request searches for the designated service data from the accumulated data (step S33). Then, the platform server 400 transmits the searched service data of the building B 100-2 to the user terminal 500 (step S34). The service data here may also include an analysis result of the service data performed by the platform server 400.

Upon receiving the transmitted service data, the user terminal 500 displays the received service data of each floor of the building B 100-2 (step S46).

Thereafter, it is assumed that the user terminal 500 has received a change in display date and time by the operation of the user (step S47).

At this time, on the basis of the changed display date and time, a transmission request of the service data, the period of which has been changed, of each floor of the building A 100-1 and the building B 100-2 is made to the platform server 400 (step S48). Here, for example, in a state where service data of one building is displayed, when a change in display date and time for one floor of the building being displayed is received, the platform server 400 performs processing of changing the display date and time of another floor of the same building to the same display date and time. Alternatively, in a state where service data of a plurality of buildings is displayed, when a change in display date and time for one building or floor being displayed is received, the platform server 400 performs processing of changing the display date and time of each floor of the all the buildings being displayed to the same display date and time.

The platform server 400 that has received the transmission request searches for the designated service data from the accumulated data (step S35). Then, the platform server 400 transmits the searched service data of the building A 100-1 and the building B 100-2 to the user terminal 500 (step S36).

Upon receiving the transmitted service data, the user terminal 500 displays the received service data, the date and time of which has been changed, of each floor of the building A 100-1 and the building B 100-2 (step S49).

### [Data Collected by Platform Server and Display Example on User Terminal]

Next, service data collected by the platform server 400 via the relay server 300 and a display example of the service data on the user terminal 500 will be described.

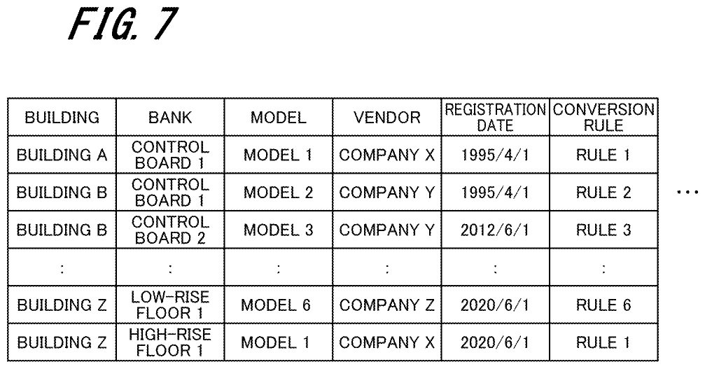

FIG. 7 illustrates an example of a site information table stored in the site information storage unit 324 of the relay server 300.

In the site information table, data regarding the elevators installed in each building (site) handled by the elevating machine operation information display system of the present example embodiment is recorded.

That is, as illustrated in FIG. 7, the site information table includes fields of building names, banks, formats, vendors, registration dates, and conversion rules.

In the building name field, names of sites (buildings) such as “building A”, “building B”, and “building C” are described.

In the bank field, the distinction of group management control boards is described. For example, when one building has a plurality of group management control boards, information for specifying the plurality of group management control boards, such as “control board 1” and “control board 2”, is described.

In addition, in a case where the group management control boards are allocated for the high-rise floor and the low-rise floor in one building as in “building Z” illustrated in FIG. 7, information for specifying the group management control boards for each floor such as “low-rise floor 1” and “high-rise floor 1” is described in the bank field.

In the format field, the format number of the model of the elevator controlled by each group management control board is described.

In the vendor field, the name of a vendor, which is a manufacturer that manufactured each group management control board, is described.

In the registration date field, the date (year/month/day) of registration of the elevator controlled by each group management control board is described.

In the conversion rule field, a rule number for converting service data collected from each group management control board is described.

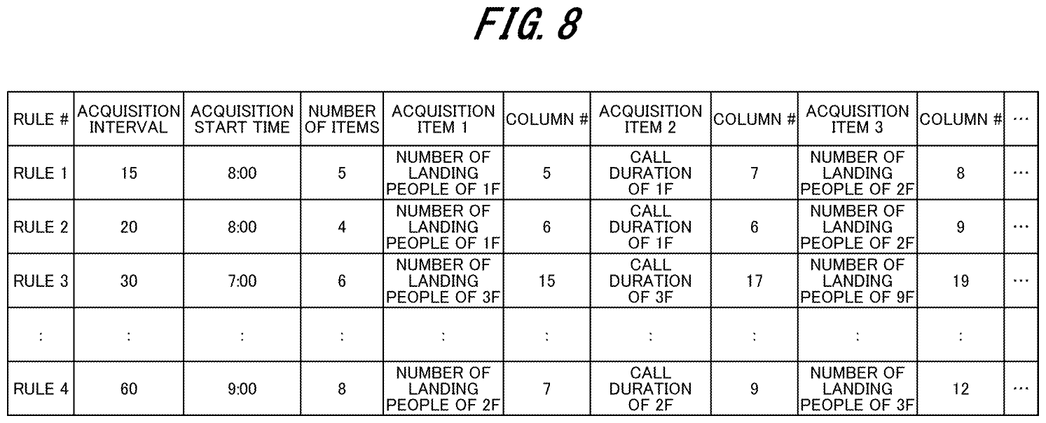

FIG. 8 illustrates a configuration of the conversion rule table 325 stored in the site information storage unit 324 of the relay server 300.

The conversion rule table 325 stores details of the conversion rule necessary for converting the service data collected from the group management control boards 200-1 to 200-N with which the relay server 300 performs communication.

The conversion rule table 325 includes fields of rule numbers, data acquisition intervals, acquisition start times, the number of items, and details of each item.

In the rule number field, an identification number assigned to each rule is described. This rule number corresponds to the rule number in the site information table illustrated in FIG. 7.

In the acquisition interval field, an interval at which the service data is acquired according to the rule is described. In the example of FIG. 8, the acquisition interval is indicated in minutes. For example, acquisition of the service data at intervals of 15 minutes is described as rule 1.

In the acquisition start time field, the time at which acquisition of daily service data is started is described. In the example of FIG. 8, 8:00 AM is indicated as rule 1, for example.

In the number of items field, the total number of pieces of data acquired as the service data is described. In the example of FIG. 8, for example, the number of pieces of data is described as five as rule 1, and the number of pieces of data is described as four as rule 2.

Details of each acquisition item are described in the fields of acquisition items 1, 2, 3, . . . . The acquisition item field is provided as many as the number of pieces of data indicated in the number of items field.

In the example of FIG. 8, for example, as rule 1, acquisition item 1 describes the number of landing people on the first floor, acquisition item 2 describes the first floor call duration from when the car call button of the hall on the first floor is pressed until the car arrives, and acquisition item 3 describes the number of landing people on the second floor. Here, the number of landing people is an accumulated value of the number of landing people in a period determined as a data acquisition interval or a value based on each rule, such as an average of the number of people of one-time car landing. The call duration is also a value based on each rule, such as an average value or a maximum value of one-time call duration.

In addition, in each of the acquisition items 1, 2, 3, . . . , a column number indicating a position (column) where the data of the corresponding item in the acquired data is described is indicated.

The relay server 300 performs processing of converting the service data acquired according to each rule in this manner into data in a unified format. For example, the data conversion unit 322 of the relay server 300 performs processing of converting data of the number of people at different intervals for each rule such as 15 minute intervals into the number of landing people on each floor at 60 minute intervals, and converting the call duration into an average or maximum value of the call duration for every 60 minutes.

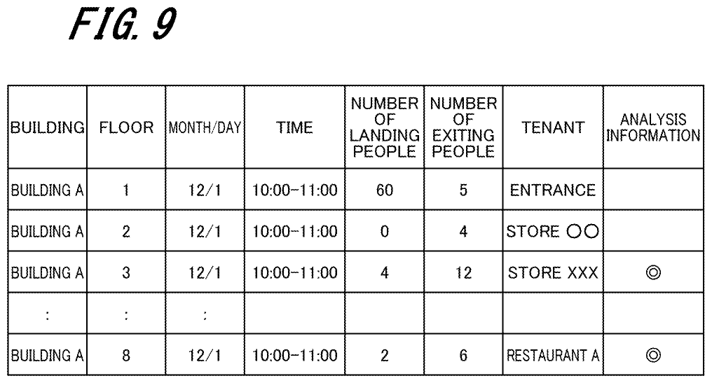

FIG. 9 illustrates an example of service data stored in the service data database 412 of the platform server 400.

The example of FIG. 9 illustrates the cumulative number of landing people and the number of exiting people for one hour from 10:00 AM to 11:00 AM on each floor from the first floor to the ninth floor of the building A. In addition, in the example of FIG. 9, a tenant name of each floor of the building A is described, and each floor and tenant information are associated with each other. In a case where a plurality of tenants occupies the corresponding floor, a plurality of tenant names may be described as the tenant name. Alternatively, one representative tenant name may be described. Details of the industry type and the like may be described in the tenant name field. Note that a lobby floor where no tenant occupies, such as the first floor, is described as entrance.

In addition, in the example of FIG. 9, the information in which the floor and the tenant name are associated with each other is indicated as an example in which different tenants occupy floors, but in a case where one tenant occupies one building, the tenant name may be added to the building information, and the information in which the building (site) and the tenant are associated with each other may be indicated.

Although FIG. 9 illustrates information of one building (building A), since the service data collected by the platform server 400 is data converted into a unified format by the relay server 300, the service data of any building is data in the same format. That is, the number of landing people and the number of exiting people on each floor per hour are indicated for buildings other than the building A.

In addition, in the example of FIG. 9, the call duration is not indicated, but similarly, for the call duration, an average or maximum call duration within the same time on the same floor is indicated.

In addition, in the case of the example of FIG. 9, in a case where there is some information to be announced by analysis by the platform server 400, a mark is added to the analysis information field.

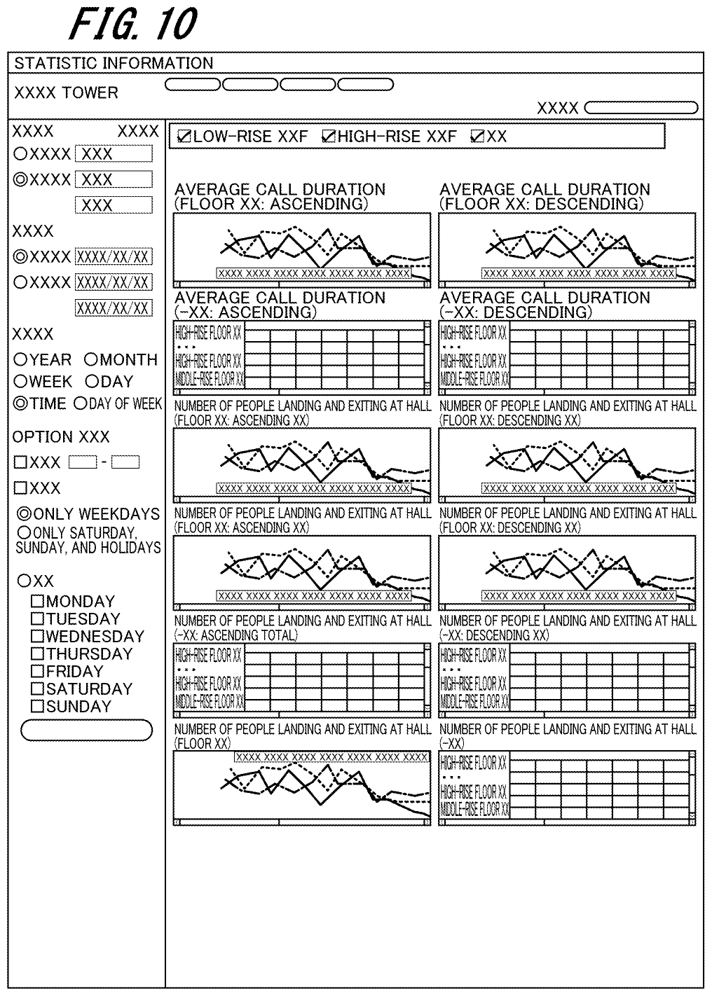

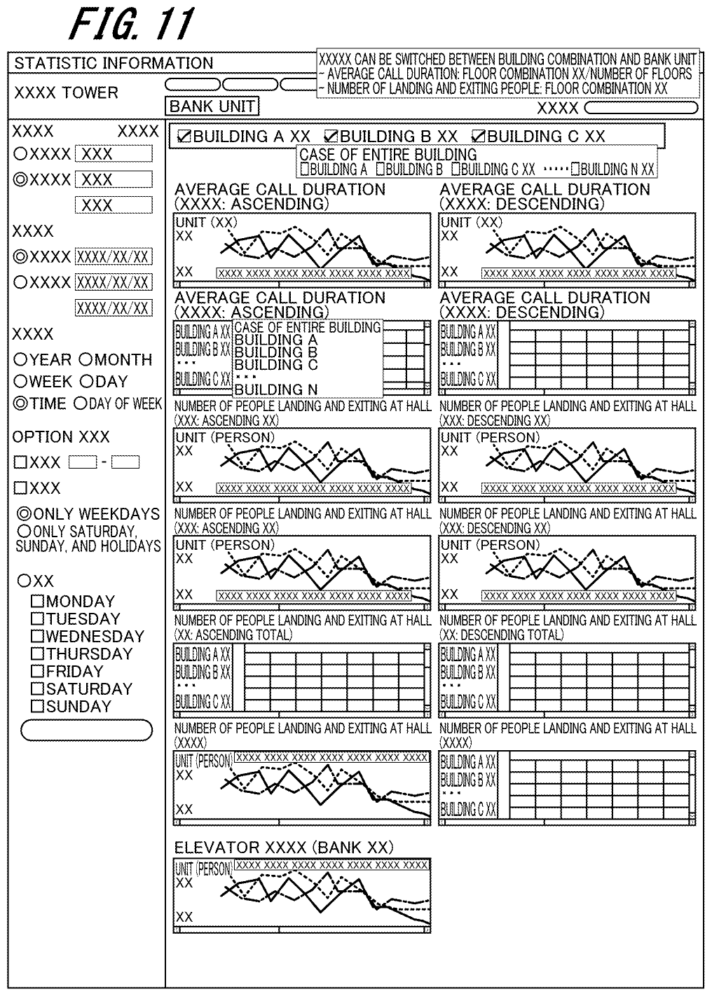

FIGS. 10 and 11 illustrate display examples of elevator service data on the user terminal 500.

In the display example of FIG. 10, regarding the average call duration of each floor in one building and the number of landing and exiting people of each floor, changes within a designated time are displayed by being distinguished between ascending and descending.

In the example of FIG. 10, a type in a building such as a low-rise floor or a high-rise floor can be selected as the selection of the display range.

In FIG. 10, line graphs indicate a change state of the average call duration of each floor, and a list of numerical values also indicates the average call duration of each floor.

In addition, in FIG. 10, the change in the number of people landing and exiting at halls on each floor is indicated by line graphs and a list of numerical values while being distinguished between ascending and descending.

Note that the data to be displayed can be selected in units of years, units of months, units of weeks, units of days, units of hours, units of days of the week, or the like. In addition, data can be selected according to the calendar, such as data of only weekdays and data of only Saturday, Sunday, and holidays.

In addition, as illustrated in FIG. 10, for the range in which the service data is displayed in time series by a graph, for example, when a display range is designated for any floor, processing is performed to obtain the same display range for the other floors in conjunction therewith. Thus, the user who operates the user terminal 500 can easily change the display range for each floor.

In the display example of FIG. 11, regarding a plurality of buildings, regarding the average call duration of each floor and the number of landing and exiting people of each floor, changes within a designated time are collectively displayed by being distinguished between ascending and descending. The example of FIG. 11 is an example in which three buildings: building A, building B, and building C are selected to be displayed.

In FIG. 11, line graphs indicate a change state of the average call duration of each building, and a list of numerical values also indicates the average call duration of each building.

Also when a plurality of buildings in FIG. 11 is collectively displayed, the data to be displayed can be selected in units of years, units of months, units of weeks, units of days, units of hours, units of days of the week, or the like. In addition, data can be selected according to the calendar, such as data of only weekdays and data of only Saturday, Sunday, and holidays.

Note that, when a plurality of buildings is collectively displayed, the average call duration and the number of landing and exiting people can be switched to the case of values where the average call duration in the entire building and the number of landing and exiting people on each floor are combined, an average call duration on each floor in the building, and the number of landing and exiting people on each floor.

In addition, as illustrated in FIG. 11, for the range in which the service data is displayed in time series by a graph, for example, when a display range is designated for any building, processing is performed to obtain the same display range for the other floors in conjunction therewith. Thus, the user who operates the user terminal 500 can easily change the display range for each building.

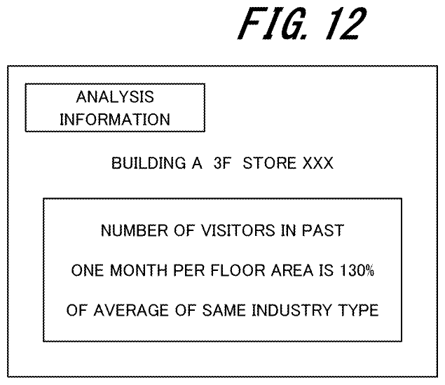

FIG. 12 illustrates a display example, on the user terminal 500, of the analysis result in the platform server 400 when the announcement information is selected in a case where there is the information to be announced illustrated in FIG. 9.

FIG. 12 illustrates a case where the third floor of the building A is selected.

The example of FIG. 12 indicates that the number of visitors in the past one month is 130% of the average of tenants of the same industry type per floor area.

At this time, an increasing status or a decreasing tendency of the number of visitors for several months on the same floor may be displayed. In addition, an average or the like of the same industry type may be displayed.

For example, when a business operator managing the building A checks this display, it is found that the number of visitors of the corresponding tenant is larger than the average of the same industry type. In such a case, the business operator managing the building A can recommend the tenant to move to another building or floor having a larger floor area.

The example of FIG. 12 is an example in a case where the number of visitors increases, but the user terminal 500 may display the analysis result also in a case where conversely a tendency in which the number of visitors decreases is detected. By displaying the tendency of the decrease in the number of visitors, the business operator managing the building A can recommend the tenant to move to another building or floor having a small floor area.

As described above, with the elevating machine operation information display system of the present example embodiment, it is possible to aggregate the movement status of people in each site from the service data of the elevators installed in each site, and it is possible to display the busy status of each floor in the site. Therefore, the business operator that manages each site can know whether each tenant is in an appropriate operation state, whether there is a possibility that the tenant moves to another building or floor, and the like. In particular, since a plurality of sites and a plurality of floors can be compared and displayed, not only the tendency in a specific building but also the tendency depending on an industry type or a region can be understood, and appropriate determination can be made.

<Modification>

Note that the present invention is not limited to the above-described example embodiment, and includes various modifications.

For example, in the above-described example embodiment, the relay server 300 converts the service data collected from each group management control board into service data in a unified format, and sends the converted data to the platform server 400. On the other hand, the relay server 300 may be omitted, and the platform server 400 may directly collect service data from each group management control board and convert the collected service data into service data in a unified format. Conversely, each building may include the relay server 300, and the service data obtained by the group management control board may be converted in the building and then transmitted to the platform server 400.

In addition, the service data collected by the relay server 300 and the platform server 400 indicates the number of landing and exiting people and the call duration on each floor in the above-described example embodiment, but may be other elevator operation information. For example, in the case of an elevator including the number of people in the elevator hall of each floor and the number of people in the car, these pieces of operation information may be collected. In addition, in FIGS. 10 and 11, both the number of landing and exiting people and the call duration in each building and each floor are illustrated, but either the number of landing and exiting people or the call duration may be collected and displayed.

Further, in the above-described embodiment, the operation information (service data) of the elevator, which is an example of the elevating machine, is collected, but the operation information of other elevating machines such as an escalator may be collected.

In addition, in the above-described example embodiment, the platform server 400 analyzes the operation information, but the platform server 400 may collect data and output the collected data for display on the user terminal 500, and the user terminal 500 may analyze the operation information.

In addition, the above-described example embodiment has been described in detail for the sake of easy description of the present invention, and is not necessarily limited to those including all the described configurations.

Further, in the above-described example embodiment, the device or system configuration may be changed, or a part of the processing procedure may be omitted or replaced within the scope not changing the gist of the present invention.

In addition, information such as a program in a case where the device or system is configured by executing the program can be stored in a recording device such as memory, a hard disk, and a solid state drive (SSD), or a recording medium such as an IC card, an SD card, and an optical disk.

Further, in the block diagrams of FIGS. 1 and 4, only control lines and information lines considered to be necessary for description are illustrated, and not all control lines and information lines of a product are necessarily illustrated. In practice, it may be considered that almost all the configurations are connected to each other.

### REFERENCE SIGNS LIST

101-1, 100-2 Building (site)
111 to 118 Elevator
200-1, 200-2, 200-3 Group management control board
210-1, 210-2, 210-3 Elevator control unit
300 Relay server
310 CPU (central control unit)
320 Main storage device
321 Service data collection unit
322 Data conversion unit
324 Site information storage unit
325 Conversion rule table
330 External storage device
331 Converted data storage unit
340 Input/output unit
400 Platform server
411 Site information table
412 Service data database
500 User terminal
501 Display unit
502 Input unit

1. An elevating machine operation information display system comprising:
a collection unit that collects, from one or more control boards that control a plurality of elevating machines installed in a same site, operation information of the elevating machines for each period set for the elevating machines;
a data conversion unit that converts the operation information collected by the collection unit to operation information at preset intervals; and
an output unit that outputs, for display, elevating machine usage information that includes at least one of an average call duration and a number of people landing and exiting at halls in the site on a basis of the operation information converted by the data conversion unit.

2. The elevating machine operation information display system according to claim 1, wherein
the conversion unit converts the operation information in units of floors of the site, and
the output unit outputs the operation information converted in units of floors in time series.

3. The elevating machine operation information display system according to claim 2, wherein
the output unit is capable of displaying operation information regarding a plurality of floors, and when an operation information display period of a first floor is changed, changes an operation information display period of a second floor to a same period as the display period of the first floor.

4. The elevating machine operation information display system according to claim 1, wherein
the collection unit is configured to be capable of collecting operation information of elevating machines installed in a plurality of sites,
the conversion unit converts the operation information in units of sites, and
the output unit outputs the operation information converted in units of sites in time series.

5. The elevating machine operation information display system according to claim 4, wherein
the information output by the output unit is capable of displaying the operation information of the plurality of sites simultaneously or by switching, and when an operation information display period of a first site is changed, an operation information display period of a second site is changed to a same period as the operation information display period of the first site.

6. The elevating machine operation information display system according to claim 2, wherein
the operation information output by the output unit is output in association with a tenant that uses the floor or the site.
